(19) United States
(12) Patent Application Publication
(10) Pub. No.: US 2026/0127818 A1
(43) Pub. Date: May 7, 2026

(54) Method of Generating Three-Dimensional Model from Single Image

(71) Applicant: K.E.A. Design Consultants, Inc., Taipei City (TW)

(72) Inventors: Che-Rung Lee, Hsinchu City (TW); Iuan-Kai Fang, Taipei City (TW)

(21) Appl. No.: 19/378,662

(22) Filed: Nov. 4, 2025

(30) Foreign Application Priority Data
Nov. 6, 2024 (TW) 113142428

(51) Int. Cl. G06T 17/00; G06T 7/13; G06T 7/194; G06V 10/26; G06V 10/764; G06V 10/774; G06V 10/82; G06V 20/70

(52) U.S. Cl. CPC G06T 17/00; G06T 7/13; G06T 7/194; G06V 10/26; G06V 10/764; G06V 10/774; G06V 10/82; G06V 20/70; G06T 2207/10024; G06T 2207/20081; G06T 2207/20084; G06T 2210/04; G06T 2210/32

(57) ABSTRACT

A method of generating three-dimensional model from single image is disclosed. The method includes the following steps: inputting a plurality of two-dimensional images containing an assembled product, conducting manual annotation process to product components for establishing a component data set; training the images in the component data set and establishing a semantic segmentation network model. The semantic segmentation network model converts the graphic characteristics of the graphic data into component images; inputting the image to be converted, identifying the product category of the image to be converted, and selecting the corresponding component data set; conducting component segmentation by the semantic segmentation network model and separating the image to be converted into multiple components; and combining the multiple components by the geometry information and object description in the description file to form a three-dimensional product model.

### CROSS-REFERENCE TO RELATED APPLICATION

The present application claims priority to, and the benefit of, Taiwan Patent Application No. 113142428, filed on Nov. 6, 2024, in the Taiwan Intellectual Property Office, the disclosure of which is incorporated by reference herein in its entirety.

### BACKGROUND OF THE INVENTION

### 1. Field of the Invention

The present disclosure relates to a method for generating a three-dimensional model from a single image, and more particularly to a method for constructing a three-dimensional model from a single image of an assembled product, and the generated model includes detailed component models of the assembled product.

### 2. Description of the Related Art

Converting two-dimensional (2D) images into three-dimensional (3D) objects or models is a classic problem in the field of computer vision. During the process of capturing 2D images, many important geometric properties may be lost or distorted, leading to ambiguity and making the reconstruction theoretically intractable. To overcome the difficulties of such transformation, existing technologies often rely on multi-view image synthesis, which involves identifying corresponding points across multiple images taken from different angles, and establishing spatial correspondences to reconstruct a 3D object. However, multi-view image synthesis may fail to accurately represent the original object's characteristics, and obtaining multiple images from different viewpoints is not always feasible in real-world scenarios.

For example, in the interior design industry, designers frequently use 3D modeling software (such as SketchUp, Rhinoceros 3D, or 3D Max) to visualize design concepts. By scaling, translating, and rotating different objects within a virtual space, designers are able to simulate and present various design outcomes for client's review. Nevertheless, during discussions regarding additional objects for the interior space, only a single image may be provided by the clients, which may be sourced from the internet, magazines, or casual photographs. It is impractical to expect clients would supply images of the desired object from multiple angles for reconstruction and modeling. Consequently, designers must manually create a 3D model of the required object based on the provided image before integrating it into the existing design. This modeling process consumes significant amount of time and labor, increasing overall project cost and reducing design efficiency.

Moreover, most existing 2D-to-3D model conversion technologies are limited to reconstructing only the overall contour of the object in the image. If the object is an assembled product, the resulting 3D model typically may not be able to be decomposed into its constituent components. Therefore, individual parts must be redrawn or modeled separately, which compromises usability and flexibility.

In view of the above, although certain technologies for converting 2D images into 3D models have been proposed, they generally rely on multi-image synthesis and still suffer from limitations in conversion accuracy. In particular, the built 3D model is not provided with the capability to extract and manipulate individual components from assembled products, thereby restricting practical applications. To address these issues, a method for generating a three-dimensional model from a single image is conceived and developed, so as to overcome the shortcomings of existing techniques and enhance implementation and industrial utility.

### SUMMARY OF THE INVENTION

In view of the aforementioned problems in the prior art, an object of the present disclosure is to provide a method for generating a three-dimensional model from a single image, so as to address the issues in conventional conversion methods, which are incapable of accurately constructing 3D models and generating disassembled component models of a product.

According to one purpose of the present disclosure, a method of generating a three-dimensional model from a single image is provided, the method includes following steps: inputting a plurality of two-dimensional images including an assembled product, conducting a manual annotation process to product components of the plurality of two-dimensional images to establish a component data set; training a plurality of records of graphic data in the component data set and establishing a semantic segmentation network model, in which the semantic segmentation network model converts graphic characteristics of the plurality of records of graphic data into component images; inputting an image to be converted, identifying a product category of the image to be converted, and selecting the corresponding component data set according to the product category; conducting component segmentation by the semantic segmentation network model and separating the image to be converted into a plurality of components, each of the plurality of components including a description file; and combining the plurality of components by geometry information and an object description in the description file to form a three-dimensional product model.

Preferably, the manual annotation process includes performing manual background removal and color block segmentation and labeling on the plurality of two-dimensional images, and the plurality of records of graphic data includes an original graphic data, a background-removed graphic data and a color block labeled graphic data.

Preferably, the manual labeling operation includes adding a semantic annotation to the color block labeled graphic data, and the semantic annotation includes an addition or removal of the components, a combination of component types, a conversion of component functions, a change of component materials and a perceptual size difference.

Preferably, the semantic segmentation network model is an encoder-and-decoder architecture based on a conditional generative adversarial network, the component image is generated from the plurality of records of graphic data, and an output result is determined by a Markov discriminator.

Preferably, the semantic segmentation network model includes a self-propagation mechanism and a self-attention mechanism.

Preferably, the geometric information includes a contour detection result of the plurality of components, the contour detection result includes a coordinate position and vector information, and the object description includes relative positional relationships of the plurality of components.

Preferably, the method of generating the three-dimensional model from the single image further includes following steps: refining the three-dimensional product model by modifying respective components of the three-dimensional product model to form a three-dimensional fine model.

Preferably, the method of generating the three-dimensional model from the single image further includes following steps: importing the three-dimensional product model into three-dimensional drawing software to generate a three-dimensional drawing model corresponding to the assembled product.

Preferably, the assembled product includes a furniture product, a home appliance product, or an automotive product.

Preferably, the furniture product includes a chair, table, bed, sofa, or cabinet.

Therefore, the method of generating the three-dimensional model from the single image according to the present disclosure is able to provide one or more of the following advantages:
(1) The method of generating the three-dimensional model from the single image enables the conversion of the single image into the three-dimensional model of an object, thereby reducing the time required for illustrators or modelers to construct 3D models, which significantly lowers labor demand, reduces operational costs, and improves operational efficiency.
(2) The method of generating the three-dimensional model from the single image allows the creation of the component data set through the manual annotation process, and the components of the assembled product are labeled and described. By segmenting the object and building individual three-dimensional models for each component, the assembled product's 3D model may be constructed by combining the individual models, which not only enhances the accuracy of the conversion but also expands the applicability of the model due to its disassemblable component structure.
(3) The method of generating the three-dimensional model from the single image supports integration with three-dimensional drawing software, allowing the three-dimensional product model to be imported, which improves compatibility and enhances operational convenience.

### BRIEF DESCRIPTION OF THE DRAWINGS

The patent or application file contains at least one drawing executed in color. Copies of this patent or patent application with color drawing(s) will be provided by the Office upon request and payment of the necessary fee.

In order to make the technical features, contents and advantages of the present invention and the effects that can be achieved more obvious, the present invention is described in detail as follows with reference to the accompanying drawings and in the form of an embodiment:

FIG. 1 is a flowchart illustrating the method for generating a three-dimensional model from a single image according to one embodiment of the present disclosure.

FIG. 2 is a schematic diagram illustrating a manual annotation process according to one embodiment of the present disclosure.

FIG. 3 is a schematic diagram illustrating a semantic annotation format according to one embodiment of the present disclosure.

FIG. 4 is a schematic diagram illustrating a semantic segmentation network model according to one embodiment of the present disclosure.

FIG. 5 is a schematic diagram illustrating component segmentation according to one embodiment of the present disclosure.

FIG. 6 is a flowchart of the method of generating the three-dimensional model from the single image according to another embodiment of the present disclosure.

FIG. 7 is a block diagram illustrating a machine able to read computer codes from a computer-readable medium and perform any of the methodologies discussed herein, according to an example embodiment.

### DETAILED DESCRIPTION OF THE PREFERRED EMBODIMENTS

In order to facilitate understanding of the technical features, contents and advantages of the present invention and the effects that can be achieved, the present invention is hereby described in detail as follows with the accompanying drawings and in the form of embodiments. The drawings used therein are only for illustration and auxiliary description, and may not be the true proportions and precise configurations after the implementation of the present invention. Therefore, the proportions and configurations of the attached drawings should not be interpreted to limit the scope of rights of the present invention in actual implementation. In order to facilitate understanding of the technical features, contents and advantages of the present disclosure and the effects that can be achieved, the present invention is hereby described in detail as follows with the accompanying drawings and in the form of embodiments. The drawings used therein are only for illustration and auxiliary description, and may not be the true proportions and precise configurations after the implementation of the present disclosure. Therefore, the proportions and configurations of the attached drawings should not be interpreted to limit the scope of rights of the present disclosure in actual implementation.

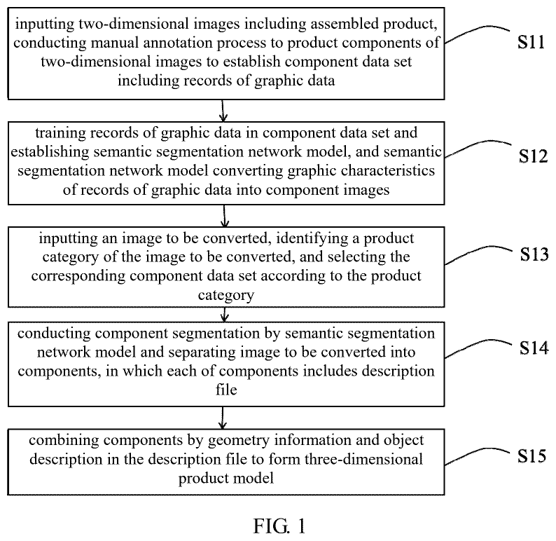

Referring to FIG. 1, FIG. 1 is a flowchart illustrating the method for generating a three-dimensional model from a single image according to one embodiment of the present disclosure. As shown in FIG. 1, the method of generating a three-dimensional model from a single image includes the following steps (S11-S15):

Step S11: inputting a plurality of two-dimensional images including an assembled product, conducting a manual annotation process to product components of the plurality of two-dimensional images to establish a component data set including a plurality of records of graphic data. First, two-dimensional images of a plurality of assembled products are input to construct a component data set associated with the assembled products. The term “assembled product” refers to a physical object composed of multiple components, assemblies, or parts, such as furniture products, home appliance products, or automotive products. Among these assembled products, different components may have distinct appearances, structures, or functions, and are assembled or combined through an assembly process to form the final physical product. In the present embodiment, a furniture product is used as an example of the assembled product. The furniture product may include, but is not limited to, a chair, table, bed, sofa, or cabinet. In other embodiments, the assembled product may also be a home appliance product such as an electrical device or computer, or an automotive product such as a sedan or truck of various vehicle types.

The plurality of two-dimensional images of the furniture product may be obtained by photographing the furniture item or collecting related images. These graphic data may be stored in a memory of a computing device or in various types of databases via an input interface or a network interface of the computing device. The computing device may be a server, personal computer, laptop, tablet, smartphone, or other suitable device. A processor within the computing device may execute control instructions to access a plurality of graphic data stored in memory or a database and perform the steps of the three-dimensional image conversion process. Taking a furniture product as an example, a data structure of the component data set may be divided into four hierarchical levels: image format, furniture category, furniture function, and component category. The image format may include original graphic data (raw data), background-removed graphic data (object data), and color block labeled graphic data (notation data). The furniture category may include classifications such as chair, table, bed, sofa, cabinet, and the like. For the furniture function, taking a table as an example, it may be further classified into general table, small table, coffee table, office desk, or workbench. For the component category, again using a table as an example, it may include various components such as tabletop, table legs, support frame, and base, each represented by a different color block.

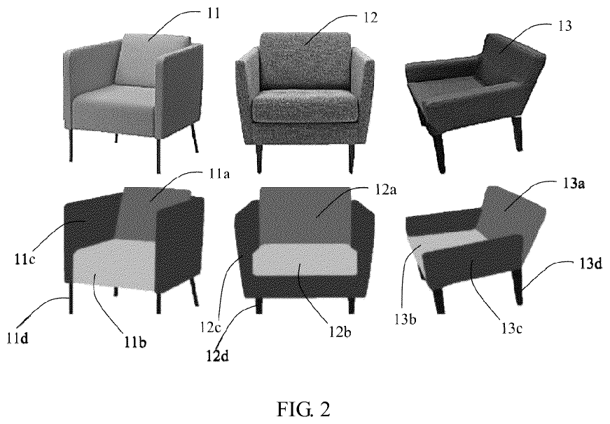

In the component data set, in addition to original photographic images, a manual annotation process must be performed on the images to generate corresponding color block labeled graphic data. Referring to FIG. 2, FIG. 2 is a schematic diagram illustrating a manual annotation process according to one embodiment of the present disclosure. As shown in FIG. 2, using chairs as an example of furniture products, three photographic images of chairs are obtained, including a first chair 11, a second chair 12, and a third chair 13. A manual annotation process is performed on the first chair 11, the second chair 12, and the third chair 13, including manual background removal and color block segmentation and labeling. After the original images are stored as original graphic data, background regions other than the chairs are removed to reveal the external shape of the furniture product. In the present embodiment, the images of the first chair 11, the second chair 12, and the third chair 13 are all background-removed images, which are stored as background-removed graphic data. Subsequently, color block segmentation and labeling are applied to the background-removed graphic data, that is, semantic segmentation is performed on the image, and each pixel in the image is classified to form color block labeled graphic data, in which each color represents a component classification. For example, in the case of the first chair 11, the first color (e.g. gray) region 11a represents the backrest, the second color (e.g. green) region 11b represents the seat cushion, the third color (e.g. brown) region 11c represents the armrest, and the fourth color (e.g. purple) region 11d represents the chair legs. Similarly, in the second chair 12 and third chair 13, the first color (e.g. gray) regions 12a and 13a are labeled as backrests, the second color (e.g. green) regions 12b and 13b are labeled as seat cushions, the third color (e.g. brown) regions 12c and 13c are labeled as armrests, and the fourth color (e.g. purple) regions 12d and 13d are labeled as chair legs. The color block labeled graphic data, after annotation, is stored together with the original graphic data and background-removed graphic data to form a component data set for the chair.

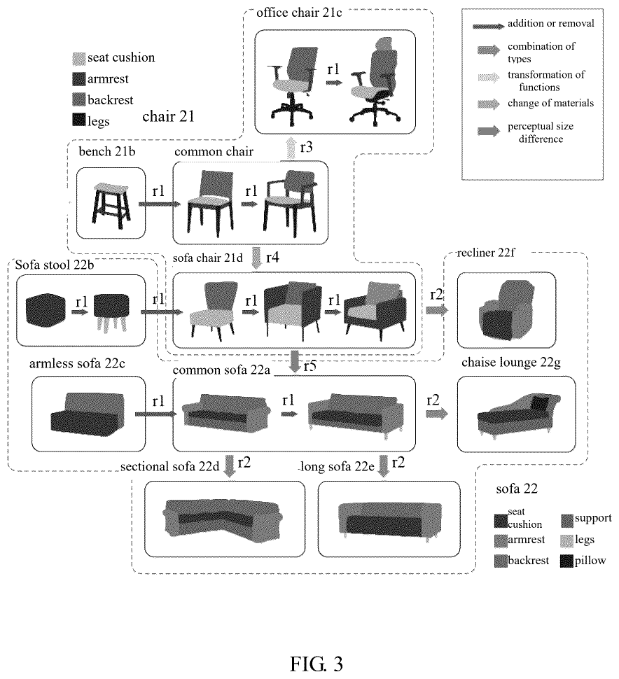

In the present embodiment, the manual labeling operation includes adding a semantic annotation to the color block labeled graphic data. Referring to FIG. 3, FIG. 3 is a schematic diagram illustrating a semantic annotation format according to one embodiment of the present disclosure. As shown in FIG. 3, the semantic segmentation and labeling is performed using the chair 21 and the sofa 22, both of which belong to the furniture category, as examples. The chair 21 is categorized by function into a common chair 21a, a bench 21b, an office chair 21c, and a sofa chair 21d. The component categories of the chair 21 are labeled with different color blocks: the second color (e.g. green) area represents the seat cushion, the third color (e.g. brown) area represents the armrest, the first color (e.g. gray) area represents the backrest, and the fourth color (e.g. purple) area represents the legs. Similarly, the sofa 22 is categorized by function into a common sofa 22a, an sofa stool 22b, an armless sofa 22c, a sectional sofa 22d, a long sofa 22e, a recliner 22f, and a chaise lounge 22g. The component categories of the sofa 22 are also labeled with different color blocks: the first color (e.g. purple) area represents the seat cushion, the second color (e.g. light blue) area represents the armrest, the third color (e.g. magenta) area represents the backrest, the fourth color (e.g. pink) area represents the support, the fifth color (e.g. yellow) area represents the legs, and the sixth color (e.g. dark blue) area represents the pillow.

In addition to the aforementioned classification and labeling, semantic annotations are further established for the color block labeled graphic data to generate design-related associative relationships. The semantic annotations include an addition or removal of components r1, a combination of component types r2, a conversion of component functions r3, a change of component materials r4, and a perceptual size difference r5.

The addition or removal of components r1 refers to changes in geometric components of furniture that affect the classification of the furniture. For example, when the armrests and backrest of a common chair 21a are removed, it becomes a new category: a bench 21b. Considering the interaction between furniture design and human activity within space, corresponding furniture categories are established to reflect their significance. For example, although a common sofa 22a and an armless sofa 22c are not clearly distinguished in real life, a common sofa 22a typically has armrests and allows users to sit only from the front. In contrast, the armless sofa 22c lacks armrests, thereby offering seating access from both sides and allowing users to lie down naturally, serving as a sofa bed. Therefore, the presence or absence of armrests affects the categorization of the furniture, indicating that the existence of specific components in an assembled product is directly related to the way the assembled product is defined.

The combination of component types r2 refers to different arrangements of components forming different categories of furniture. Taking sofa 22 as an example, the common sofa 22a and the chaise lounge 22g share a similar set of component types. However, the alignment of the armrests and backrest along the shorter or longer side of the seat varies between the two. As a result, the common sofa 22a is usually used in a sitting posture, while the chaise lounge 22g is more often used in a reclining manner. Thus, semantic annotations are added according to the form of the components.

The transformation of component functions r3 refers to the formation of different furniture types based on the functional adaptation of components. For instance, in the case of chairs 21, the primary difference between a common chair 21a and an office chair 21c lies in the variation of their legs. A common chair 21a is designed merely to support the human body, whereas an office chair 21c needs to allow rotation and ease of movement. As such, it is converted into a single-column, eight-pronged structure with wheels, illustrating how the function of a component can induce random changes in its form.

The change of component materials r4 refers to how a change in material may lead to a new furniture category. For example, if the seat cushion and backrest of a common chair 21a are replaced with soft padded materials, it becomes a sofa chair 21d. This material change alters both the usage and context of the furniture, thereby defining a new category.

The perceptual size difference r5 refers to how the human perception of scale plays a significant role in defining the furniture category. For example, the appearance of the sofa chair 21d is very similar to that of the common sofa 22a. The narrower one is categorized as the sofa chair 21d, while the wider one is categorized as the common sofa 22a. This distinction illustrates the perceptual difference based on human recognition. Classifying furniture based on actual dimensional changes of components as a standard further clarifies the categorization system.

Step S12: training the plurality of records of graphic data in the component data set and establishing a semantic segmentation network model, and the semantic segmentation network model converting graphic characteristics of the plurality of records of graphic data into component images. After building the component database for various assembled products, a training process is performed on the graphic data within the component database to establish a semantic segmentation network model. The semantic segmentation network model may be an encoder-and-decoder architecture based on a conditional generative adversarial network (CGAN), which generates component images from the plurality of graphic data.

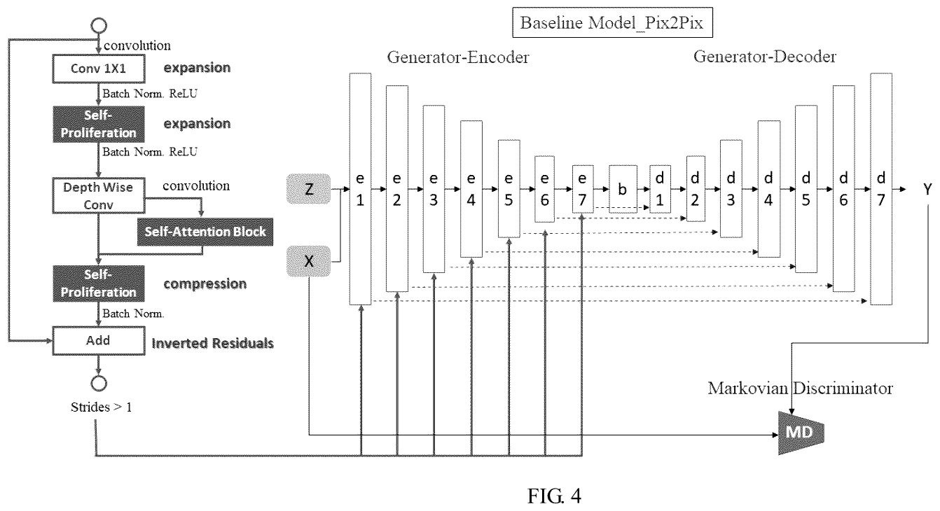

Referring to FIG. 4, FIG. 4 is a schematic diagram illustrating a semantic segmentation network model according to one embodiment of the present disclosure. As shown in FIG. 4, the semantic segmentation network model MD may be an encoder-and-decoder architecture based on a conditional generative adversarial network. Built on the baseline model of image-to-image translation (Pix2Pix), it automatically generates images that satisfy certain conditions or features. That is, the input single image X is processed through the encoder and decoder operations of the generator in the baseline model to automatically generate the component image Y, and the output result is judged by a Markovian discriminator.

In this embodiment, self-replication mechanism and self-attention mechanism are additionally incorporated into convolutional layers of the encoder. The function of the self-attention mechanism may be described as mapping a query and a set of key-value pairs to an output, where the query, keys, values, and output are all vectors. The output is computed as a weighted sum of the values, where the weight assigned to each value is determined by the corresponding key. The self-attention mechanism is a type of sequence transduction model used for processing complex loops or convolutional neural networks within encoder and decoder configurations. The self-attention mechanism completely eliminates recurrence and convolution. When dealing with large amounts of data, replacing convolutional neural networks with self-attention can simplify the architecture and focus on the extracted features.

The self-replication mechanism, on the other hand, increases the number of feature values effectively through algorithms of self-copying and self-growth. When executing a convolutional neural network, each filter's parameters are initialized randomly, and the sampling of features is also random. Random feature sampling helps mitigate the problem of overfitting to the training data, preventing the model from relying excessively on locally specific features. Additionally, random sampling enhances the model's robustness to noise and variability. Even in the presence of noise or interference, the model can still extract useful information from randomly selected features, thereby maintaining good performance.

The semantic segmentation network model MD uses a series of linear transformations to generate more feature maps with lower computational cost, and this is achieved through the use of a expansion mechanism. Next, the self-attention mechanism is applied in both the channel and spatial dimensions to capture the long-range dependencies of the feature maps. The model may be configured as a seven-layer convolutional neural network (CNN). When data is passed through each layer of the CNN, the model duplicates the same number of feature maps and integrates them into the self-attention mechanism. Then, through a compression mechanism, the encoding of each layer is completed by applying the self-proliferation mechanism, which is computed using inverted residuals.

Step S13: inputting an image to be converted, identifying a product category of the image to be converted, and selecting the corresponding component data set according to the product category. After establishing the component data set of the assembled product and training the data set to build the semantic segmentation network model, an image to be converted is input. The image to be converted is a two-dimensional single image of the object to be analyzed. This image may be classified by a classifier to identify the category of the assembled product, thereby selecting the corresponding component data set of that product category for subsequent component segmentation processes.

Step S14: conducting component segmentation by the semantic segmentation network model and separating the image to be converted into a plurality of components, in which each of the plurality of components includes a description file. The semantic segmentation network model is operated by using the component dataset corresponding to the assembly product category, and the input image to be converted is segmented into components. The components in the two-dimensional single image are separated and extracted to form multiple component images. Each component image contains a description file for the component, and the description file includes geometry information and object description. The geometry information and object description in the description file incorporate human prior knowledge (or common sense), such as the fact that a chair includes four legs and that the legs are identical or symmetrical. These description files provide characteristic information for component generation. Even if certain chair legs are obscured in the single image due to viewing angle, the description file can assist in generating the correct number of legs. The description files may be manually created, for example, by manually entering the description file for each component during the annotation process. However, the present disclosure is not limited thereto. In other embodiments, such prior knowledge in the description files may also be achieved using machine learning techniques—for example, automatically generating the corresponding description file using a Chat Generative Pre-trained Transformer (ChatGPT).

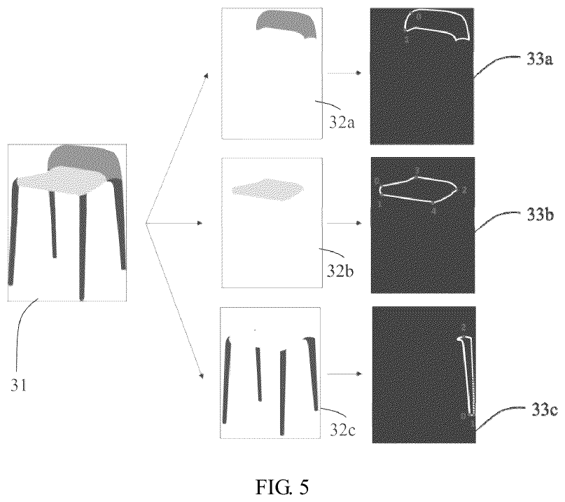

Referring to FIG. 5, FIG. 5 is a schematic diagram illustrating component segmentation according to one embodiment of the present disclosure. As shown in FIG. 5, the original two-dimensional image to be converted is processed through the semantic segmentation network model, generating a component image 31 that includes each component region. Based on the component categories, it is segmented into a backrest component image 32a, a seat cushion component image 32b, and a leg component image 32c. According to the information in the component data set, the backrest component image 32a, the seat cushion component image 32b, and the leg component image 32c can each include their respective object description information. For example, annotations describing the relative positional relationships among the backrest, seat cushion, and legs The backrest component image 32a, the seat cushion component image 32b, and the leg component image 32c are further subjected to a component contour detection procedure to obtain the contour detection results of each component, including a backrest contour image 33a, a seat cushion contour image 33b, and a leg contour image 33c. Based on the contour detection results, the coordinate positions of each component's contour and the vector information between positioning points may be obtained, serving as reference data for subsequent combination and modeling.

Step S15: combining the plurality of components by geometry information and an object description in the description file to form a three-dimensional product model. According to each segmented component image, a corresponding three-dimensional component model is individually constructed. These three-dimensional component models are then assembled into a three-dimensional product model corresponding to the image to be converted, based on the content of the description files, for example, by utilizing the relative positional relationships of components described in the object description, along with the coordinate positions and vector information of the positioning points obtained from the contour detection. Since the three-dimensional product model is formed by combining multiple components, it can also be easily disassembled into individual component models during operation. For instance, when a designer is creating a design drawing and wishes to explore the visual effect of placing different types of chairs, the seat cushion, backrest, armrest, and legs of a standard chair may be added or removed individually. This enables quick construction of various chair models without the need to redraw entirely new chair models, significantly improving design and drafting efficiency.

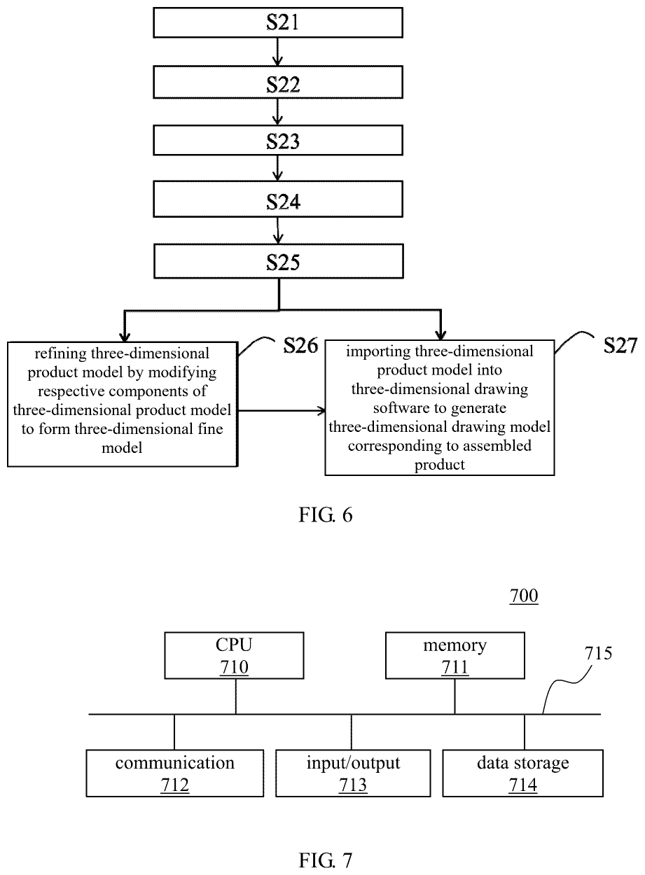

Referring to FIG. 6, FIG. 6 is a flowchart of the method of generating the three-dimensional model from the single image according to another embodiment of the present disclosure. As shown in FIG. 6, the method of generating a three-dimensional model from a single image includes the following steps (S21-S27):

Step S21: inputting a plurality of two-dimensional images including an assembled product, conducting a manual annotation process to product components of the plurality of two-dimensional images to establish a component data set including a plurality of records of graphic data. Step S22: training the plurality of records of graphic data in the component data set and establishing a semantic segmentation network model, and the semantic segmentation network model converting graphic characteristics of the plurality of records of graphic data into component images. Step S23: inputting an image to be converted, identifying a product category of the image to be converted, and selecting the corresponding component data set according to the product category. Step S24: conducting component segmentation by the semantic segmentation network model and separating the image to be converted into a plurality of components, in which each of the plurality of components includes a description file. Step S25: combining the plurality of components by geometry information and an object description in the description file to form a three-dimensional product model.

Step S21 to step S25 correspond to step S11 to step S15 of the aforementioned embodiments. Reference is made to the description of the aforementioned embodiment, and the same contents will not be repeated. In the present embodiment, the method of generating a three-dimensional model from a single image further includes the following steps:

Step S26: refining the three-dimensional product model by modifying respective components of the three-dimensional product model to form a three-dimensional fine model. The three-dimensional product model generated through steps S21 to S25 may be further refined by performing a refinement process. In this process, objects with rough or insufficiently smooth shapes are modified and edited with enhanced detail. This refinement relies on prior knowledge from respective assembly product domains to correct deviations or restore missing details that may occur during the conversion process, thereby enabling the resulting three-dimensional refined model to more accurately represent the object's external structure and achieve high-quality three-dimensional model output.

Step S27: importing the three-dimensional product model into three-dimensional drawing software to generate a three-dimensional drawing model corresponding to the assembled product. The method of generating the three-dimensional model from the single image in this embodiment may be executed through a computational program or an application. By installing software programs or integrating application programming interfaces (APIs), the method may be incorporated into existing three-dimensional drawing software, allowing the three-dimensional product model generated by the present disclosure to be directly created and imported into the 3D drawing software, thereby forming a three-dimensional drawing model that may be operated and edited within the 3D drawing software. A user can easily convert a single image into a three-dimensional product model and create a corresponding three-dimensional drawing model within the 3D drawing software. In addition to improving drawing efficiency, the ability to disassemble the model into component models allows for the straightforward addition or removal of specific components, thereby expanding the range of applications for the model.

FIG. 7 is a block diagram illustrating components of a machine able to read instructions from a machine-readable medium and perform any of the methodologies discussed herein, according to an example embodiment.

The shown processing system 700 includes one or more processors, including a CPU 710, one or more memories 711 (at least a portion of which may be used as working memory, e.g., random access memory (RAM)), one or more data communication device(s) 712, one or more input/output (I/O) devices 713, and one or more data storage devices 714, all coupled to each other through an interconnect 715. The interconnect 715 may be or include one or more conductive traces, buses, point-to-point connections, controllers, adapters and/or other conventional connection devices. Each processor 710 controls part of the operation of the processing system 700 and may be or include, for example, one or more general-purpose programmable microprocessors, digital signal processors (DSPs), mobile application processors, microcontrollers, application specific integrated circuits (ASICs), programmable gate arrays (PGAs), or the like, or a combination of such devices.

Each memory 711 may be or include one or more physical storage devices, which may be in the form of RAM, read-only memory (ROM) (which may be erasable and programmable), flash memory, miniature hard disk drive, or other suitable type of storage device, or a combination of such devices. Each data storage device 714 may be or include one or more hard drives, digital versatile disks (DVDs), flash memories, or the like. Each memory 711 and/or data storage 714 can store (individually or collectively) data and instructions that configure the processor(s) 710 to execute operations to implement the techniques described above. Each communication device 712 may be or include, for example, an Ethernet adapter, cable modem, Wi-Fi adapter, cellular transceiver, baseband processor, Bluetooth or Bluetooth Low Energy (BLE) transceiver, or the like, or a combination thereof. Depending on the specific nature and purpose of the processing system 700, each I/O device 713 may be or include a device such as a display (which may include a transparent AR display surface), audio speaker, keyboard, mouse or other pointing device, microphone, camera, etc. Note, however, that such I/O devices may be unnecessary if the processing system 700 is embodied solely as a server computer.

In the case of a user device, a communication device 712 may be or include, for example, a cellular telecommunications transceiver (e.g., 3G, LTE/4G, 5G), Wi-Fi transceiver, baseband processor, Bluetooth or BLE transceiver, or the like, or a combination thereof. In the case of a server, a communication device 712 may be or include, for example, any of the aforementioned types of communication devices, a wired Ethernet adapter, cable modem, DSL modem, or the like, or a combination of such devices.

Unless contrary to physical possibility, it is envisioned that (i) the methods/operations described herein may be performed in any sequence and/or in any combination, and that (ii) the components of respective embodiments may be combined in any manner.

The machine-implemented operations described above may be implemented by programmable circuitry programmed/configured by software and/or firmware, or entirely by special-purpose (“hardwired”) circuitry, or by a combination of such forms. Such special-purpose circuitry (if any) may be in the form of, for example, one or more application-specific integrated circuits (ASICs), programmable logic devices (PLDs), field-programmable gate arrays (FPGAs), system-on-a-chip systems (SOCs), etc.

Software or firmware to implement the techniques introduced here may be stored on a computer-readable storage medium and may be executed by one or more general-purpose or special-purpose programmable microprocessors. A “computer-readable medium”, as the term is used herein, includes any mechanism that can tangibly store information in a non-transitory form accessible by a machine (a machine may be, for example, a computer, network device, cellular phone, personal digital assistant (PDA), manufacturing tool, any device with one or more processors, etc.). For example, a computer-readable medium includes recordable/non-recordable media (e.g., RAM or ROM; magnetic disk storage media; optical storage media; flash memory devices; etc.), etc.

The above description is for illustrative purposes only and is not intended to be limiting. Any equivalent modifications or changes made without departing from the spirit and scope of the present disclosure shall fall within the scope of the appended claims.

What is claimed is:

1. A method of generating a three-dimensional model from a single image, the method comprising:
inputting a plurality of two-dimensional images including an assembled product, conducting a manual annotation process to product components of the plurality of two-dimensional images to establish a component data set including a plurality of records of graphic data;
training the plurality of records of graphic data in the component data set and establishing a semantic segmentation network model, the semantic segmentation network model being configured to convert graphic characteristics of the plurality of records of graphic data into component images;
inputting an image to be converted, identifying a product category of the image to be converted, and selecting the corresponding component data set according to the product category;
conducting component segmentation by the semantic segmentation network model and separating the image to be converted into a plurality of components, with each of the plurality of components including a description file; and
combining the plurality of components by geometry information and an object description in the description file to form a three-dimensional product model.

2. The method according to claim 1, wherein the manual annotation process includes performing manual background removal and color block segmentation and labeling on the plurality of two-dimensional images, and the plurality of records of graphic data includes an original graphic data, a background-removed graphic data and a color block labeled graphic data.

3. The method according to claim 2, wherein the manual labeling operation includes adding a semantic annotation to the color block labeled graphic data, and the semantic annotation includes an addition or removal of the components, a combination of component types, a conversion of component functions, a change of component materials and a perceptual size difference.

4. The method according to claim 1, wherein the semantic segmentation network model is an encoder-and-decoder architecture based on a conditional generative adversarial network, the component image is generated from the plurality of records of graphic data, and an output result is determined by a Markov discriminator.

5. The method according to claim 4, wherein the semantic segmentation network model includes a self-propagation mechanism and a self-attention mechanism.

6. The method according to claim 1, wherein the geometric information includes a contour detection result of the plurality of components, the contour detection result includes a coordinate position and vector information, and the object description includes relative positional relationships of the plurality of components.

7. The method according to claim 1, further comprising:
refining the three-dimensional product model by modifying respective components of the three-dimensional product model to form a three-dimensional fine model.

8. The method according to claim 1, further comprising:
importing the three-dimensional product model into three-dimensional drawing software to generate a three-dimensional drawing model corresponding to the assembled product.

9. The method according to claim 1, wherein the assembled product includes a furniture product, a home appliance product, or an automotive product.

10. The method according to claim 9, wherein the furniture product includes a chair, table, bed, sofa, or cabinet.
